(19) United States
(12) Patent Application Publication
(10) Pub. No.: US 2016/0186549 A1
(43) Pub. Date: Jun. 30, 2016

(54) Multi-Stage Separation Using a Single Vessel

(71) Applicants: Donald J. VICTORY, Sugar Land, TX (US); Nicholas F. Urbanski, Katy, TX (US)

(72) Inventors: Donald J. VICTORY, Sugar Land, TX (US); Nicholas F. Urbanski, Katy, TX (US)

(21) Appl. No.: 14/953,539

(22) Filed: Nov. 30, 2015

Related U.S. Application Data
(60) Provisional application No. 62/097,930, filed on Dec. 30, 2014.
(60) Provisional application No. 62/249,563, filed on Nov. 2, 2015.

(51) Int. Cl. E21B 43/34; B01D 17/02; B01D 19/00

(52) U.S. Cl. CPC E21B 43/34; B01D 19/00; B01D 19/0063; B01D 17/02

(57) ABSTRACT

Apparatuses and methods are disclosed herein for separating well fluids into gaseous and liquid components using a single vessel that achieves multiple stages of separation. In one example embodiment, a system for separating a fluid mixture into different components is disclosed. The system comprises a separator. The separator comprises a first inlet configured to receive a stream of the fluid mixture, a first stage separation section configured to provide a first stage of separation to separate the stream into a first liquid, a second liquid, and a gas at a first temperature, and a second stage separation section in fluid communication with the first stage separation section such that the first stage and the second stage separation sections operate at substantially the same pressure. The second stage separation section is configured to provide a second stage of separation to further separate the second liquid at a second temperature.

### CROSS REFERENCE TO RELATED APPLICATIONS

This application claims the priority benefit of both U.S. Provisional Patent Application 62/097,930 filed Dec. 30, 2014 entitled MULTI-STAGE SEPARATION USING A SINGLE VESSEL, and U.S. Provisional Patent Application 62/249,563 filed Nov. 2, 2015 entitled MULTI-STAGE SEPARATION USING A SINGLE VESSEL, the entirety of which are incorporated by reference herein.

### FIELD OF THE INVENTION

This disclosure relates to apparatuses and methods for separating well fluids into gaseous and liquid components. More particularly, this disclosure relates to separation using a single vessel that achieves multiple stages of separation and associated processes.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Fluids produced from a well-head include various combinations of hydrocarbon, gas, and water in liquid and gaseous forms. A separation process and associated vessels are typically used to separate the well-head fluids into constituent forms of hydrocarbon, water, and gas.

In a conventional system, well fluid may enter a first-stage separator in which the fluid is separated into hydrocarbon, water, and gas for further processing. Collected water proceeds to further water treatment, and gas proceeds to further gas conditioning. Collected hydrocarbon is heated downstream of this first-stage separator in a second-stage separator. The first-stage and second-stage separators are typically different vessels with one or more valves and/or one or more heat exchangers positioned in between. The first-stage separator may operate at a high pressure relative to the pressure in the second-stage separator. Further separation in the second-stage separator may take place in a similar fashion to that of the first-stage separator. Gas produced by the second-stage separator is compressed and sent to the same gas conditioning process as the gas exiting the first-stage separator. Further heating of the hydrocarbon and separation at lower pressures subsequent to the second-stage separator may take place as well.

While the aforementioned configuration represents a conventional system and process for initiating separation of well fluid, the conventional system and associated process does have processing shortcomings Some of the shortcomings include increased vapor (gas) recompression from lower pressure separators to higher pressures, lack of a means to pre-condition the produced gas prior to the primary gas conditioning process, use of a high number of components requiring expensive capital outlays, high operation energy requirements, resulting in high energy costs, or other shortcomings The systems, devices, and methods disclosed herein may address at least one of these shortcomings or other shortcomings known in the art.

### SUMMARY

An embodiment provides a system for separating a fluid mixture into different components, the system including a separator including a first inlet configured to receive a stream of the fluid mixture, a first stage separation section configured to provide a first stage of separation at a first temperature to separate the stream into a first liquid, a second liquid, and a first gas, a second stage separation section disposed horizontally adjacent to the first stage separation section and in fluid communication with the first stage separation section, wherein the second stage separation section is configured to provide a second stage of separation at a second temperature higher than the first temperature to further separate a second gas from the second liquid, and a gas collection section in fluid communication with the first stage separation section and the second stage separation section, and configured to receive the first gas and the second gas to form a gas mixture.

Another embodiment provides a vessel for separating a mixture into different components, the vessel including an inlet configured to receive the mixture, a first partial chamber configured to receive a first component of the mixture, a second partial chamber disposed horizontally adjacent to the first partial chamber and configured to receive a second component of the mixture, a heat exchanger located in the second partial chamber configured to transfer thermal energy to the second component to vaporize a portion of the mixture and separate a vapor from the second component, a vapor collection portion disposed above and in communication with the first partial chamber and the second partial chamber and configured to receive the vapor, and a vapor outlet configured to pass the vapor from the vessel.

Another embodiment provides a method of separating a stream in a separator, the method including separating the stream into a first component and a second component, separating the second component from a third component at a higher temperature than the first component, wherein the first component comprises a first mixture of water and hydrocarbon, wherein the second component comprises a second mixture of water and hydrocarbon, wherein the second mixture has a higher concentration of hydrocarbon than the first mixture, and wherein the third component comprises a gas, and passing at least a portion of the second component out of the separator, and passing at least a portion the third component out of the separator.

### BRIEF DESCRIPTION OF THE DRAWINGS

The advantages of the present techniques are better understood by referring to the following detailed description and the attached drawings, in which:

FIG. 1 is a schematic representation of a conventional separation system and the associated process flow;

FIG. 2 is a schematic representation of an exemplary embodiment of a separation system and the associated process flow;

FIG. 3 is a simplified process flow diagram corresponding to the system in FIG. 2;

FIG. 4 is a schematic representation of another exemplary embodiment of a separation system and the associated process flow;

FIG. 5 is a flowchart setting forth an exemplary method for processing fluid from a wellhead using a single separator;

FIG. 6 is a schematic representation of the embodiment of FIG. 2 incorporating means to conduct mass transfer within the separation system; and

FIG. 7 is a schematic representation of the embodiment of FIG. 4 incorporating means to conduct mass transfer within the separation system.

### DETAILED DESCRIPTION OF THE DRAWINGS

In the following detailed description section, specific embodiments of the present systems, devices, and techniques are described. However, to the extent that the following description is specific to a particular embodiment or a particular use of the present systems, devices, and techniques, this is intended to be for exemplary purposes only and simply provides a description of the exemplary embodiments. Accordingly, the systems, devices, and techniques are not limited to the specific embodiments described below, but rather, include all alternatives, modifications, and equivalents falling within the spirit and scope of the appended claims.

Apparatuses and associated processes are disclosed herein that incorporate a separator to initiate hydrocarbon stabilization and gas pre-treatment in a unique configuration. An arrangement is introduced that separates a well stream fluid into its water, hydrocarbon, and gas (vapor) constituent components. The apparatus includes a separation vessel or separator and a means to exchange heat with the well stream fluid that together achieves a greater than one stage of hydrocarbon vapor-liquid separation via an imposed temperature gradient.

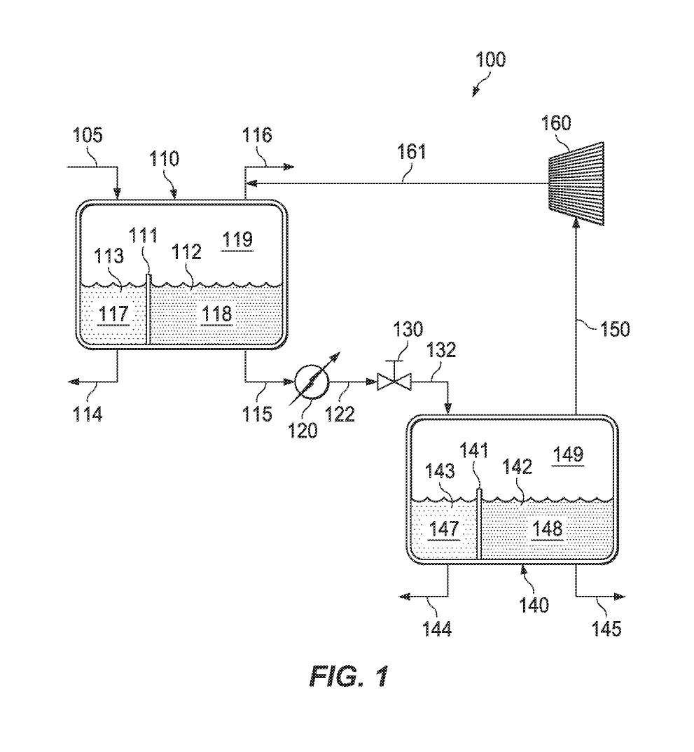

The proposed configurations combine functional aspects of a first-stage separator, such as separator 110 of FIG. 1, with multiple heat-integrated pieces to initialize stabilization of hydrocarbon at a first-stage separator pressure as well as to provide initial gas treatment. Proposed embodiments may lower capital expenditures (CAPEX) by removing a need for a compressor and a second separator. Proposed embodiments may also lower operational expenditures (OPEX) by reducing total operational energy requirements.

FIG. 1 is a schematic representation of a conventional separation system 100 and the associated process flow. The separation system 100 comprises a first separator 110 and a second separator 140. The first separator 110 receives a stream 105. In some embodiments, the stream 105 is received from a well or wellhead, and the stream 105 comprises a mixture of hydrocarbon, water, and gas. In some embodiments, there is no pressure drop from the wellhead and the stream 105 is at a temperature of about 30° C. to about 50° C. (Celsius), although other pressures and temperatures are contemplated.

A cross-section of the separator 110 is illustrated. In this example, the separator 110 comprises separation internals (not shown) that are well known in the art for separating water, hydrocarbon, and gas. For example, the separation internals may comprise a distributor baffle or an inlet vane distributor that interacts with the stream 105 to facilitate separation of gas from the stream and separation of hydrocarbon from water. As a result of the stream 105 interacting with separation internals, some amount of gas is separated from the stream 105, and a first liquid 113 is collected in a first partial chamber 117 and a second liquid 112 is collected in a second partial chamber 118. The liquids 112 and 113 may be mixtures of water and hydrocarbon with different proportions, with the first liquid 113 having a greater percentage of water relative to hydrocarbon and the second liquid 112 having a greater percentage of hydrocarbon relative to water. The partial chambers 117 and 118 can be defined by the outer walls of the separator 110 and a divider 111. The divider 111 may comprise a plate or other rigid structure for dividing a portion of the separator 110 into partial chambers. Gas may be collected in the vapor collection portion 119 of the separator 110 above the partial chambers 117 and 118. The partial chambers 117 and 118 are examples of regions or sections of the separator 110. The liquid 112 in the second partial chamber 118 may have a different composition of hydrocarbon and water than the liquid 113 because of separation that takes place due to different densities in the first partial chamber 117 with the lighter hydrocarbon constituents overflowing the first partial chamber 117 into the second partial chamber 118.

In this embodiment, the separator 110 comprises at least three outlets. The first partial chamber 117 may comprise or may be coupled to a first outlet for carrying an outlet stream 114. The outlet stream 114 may comprise mostly water and may be transported to a water treatment system (not shown) for further treatment. A second outlet may be coupled to the separator 110 at the portion 119 for carrying outlet stream 116. The outlet stream 116 may comprise mostly gas and be transported to a gas conditioning system (not shown) for further gas conditioning. The partial chamber 118 may comprise or may be coupled to a third outlet for carrying outlet stream 115. The outlet stream 115 may be transported for further processing in the separation system 100.

In this embodiment, the outlet stream 115 is provided to heat exchanger 120. In some embodiments, the outlet stream 115 at the input to the heat exchanger 120 is between about 30° C. to 50° C., and the output stream 122 flowing from the heat exchanger 120 is between about 70° C. to 90° C. The output stream 122 passes through a valve 130 to produce stream 132. The valve 130 reduces the pressure of the stream 122 as it becomes stream 132.

The stream 132 from the valve 130 is provided to the second separator 140. In an embodiment, the second separator 140 comprises an inlet for receiving the stream 132. In this example, the separator 140 comprises separation internals (not shown) that are well known in the art for separating fluids in the stream 132. For example, as discussed earlier the separation internals may comprise a distributor baffle, an inlet vane distributor, or other separation internals. The stream 132 may still comprise a mixture of hydrocarbon, water, and gas, with the proportion of hydrocarbon being higher than the original stream 105 from the wellhead.

As a result of the stream 132 interacting with separation internals, some amount of gas is separated from the stream 132, and a first liquid 143 is collected in a first partial chamber 147 and a second liquid 142 is collected in a second partial chamber 148. The liquids 142 and 143 may be mixtures of water and hydrocarbon with different proportions or concentrations, with the first liquid 143 having a greater percentage of water than hydrocarbon and the second liquid 142 having a greater percentage of hydrocarbons than water. The partial chambers 147 and 148 can be defined by the outer walls of the separator 140 and a divider 141. The divider 141 may be a plate or other rigid structure for dividing a portion of the separator 140 into partial chambers. A gas may collect in a vapor collection portion 149 of the separator 140 above the partial chambers 147 and 148.

The separator 140 comprises at least three outlets. The first partial chamber 147 may comprise or may be coupled to a first outlet for carrying an outlet stream 144. The outlet stream 144 may be transported to a water treatment system for further water treatment. A second outlet is coupled to the separator 140 at the portion 149 for carrying outlet stream 150. The outlet stream 150 may be transported to a compressor 160. The outlet stream 150 may comprise mostly gas. The partial chamber 148 may comprise or may be coupled to a third outlet for carrying outlet stream 145. The outlet stream 145 may be transported to a hydrocarbon treatment system.

The compressor 160 produces a pressure differential between input stream 150 and output stream 161, with the output stream 161 being at a higher pressure than the input stream 150. The stream 161 may be mixed with the stream 116, with the mixture transported to a gas conditioning system.

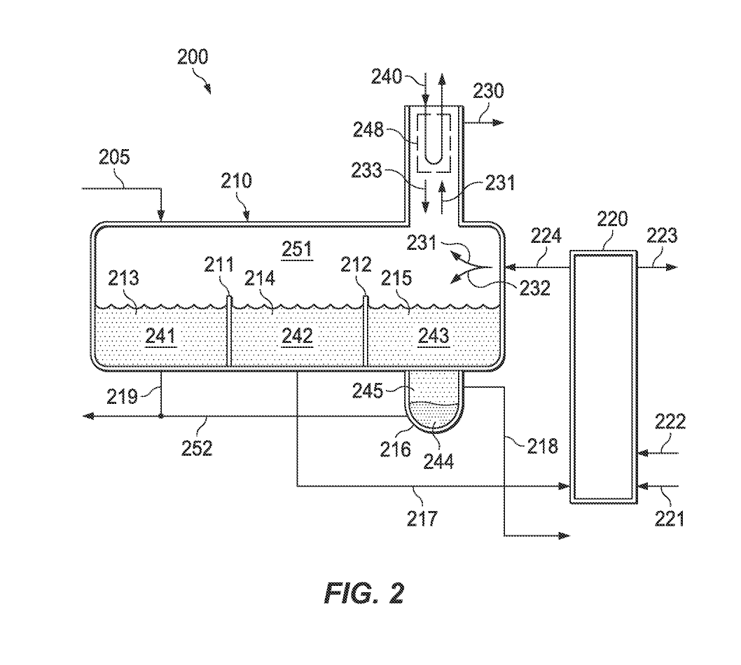

FIG. 2 is a schematic representation of an exemplary embodiment of a separation system 200 and the associated process flow. The separation system 200 comprises a separator 210 and a heat exchanger 220. The separator 210 receives a stream 205. In some embodiments, the stream 205 is from a well or wellhead, and the stream 205 comprises a mixture of hydrocarbons, water, and gas. In some embodiments, there is no pressure drop from the wellhead and the stream 205 is at a temperature of about 30° C. to about 50° C.

A cross-section of the separator 210 is illustrated. In this example, the separator 210 comprises separation internals (not shown) that are well known in the art for separating water, hydrocarbons, and gas. For example, the separation internals may comprise a distributor baffle, an inlet vane distributor, or other distributor that interacts with the stream 205 to facilitate separation of gas from the stream and separation of hydrocarbons from water. As a result of the stream 205 interacting with separation internals, some amount of gas is separated from the stream 205, and a first liquid 213 is collected in a first partial chamber 241 and a second liquid 214 is collected in a second partial chamber 242. The liquids 213 and 214 may be mixtures of water and hydrocarbon with different proportions, with the first liquid 213 having more water than hydrocarbon and the second liquid 214 having more hydrocarbon than water. The partial chambers 241 and 242 can be defined by the outer walls of the separator 210 and dividers 211 and 212 as shown. The dividers 211 and 212 may each comprise a plate or other rigid structure for dividing a portion of the separator 210 into partial chambers, e.g., a weir, and may each extend vertically across some but not all of the separator 210. The liquid 214 in the second partial chamber 242 may have a different composition of hydrocarbon and water than the liquid 213 because of separation that takes place due to different densities in the first partial chamber 241 with the lighter hydrocarbon constituents overflowing into the second partial chamber 242.

The separator 210 may comprise or may be coupled to at least four outlets. The first partial chamber 241 may comprise or may be coupled to a first outlet for carrying an outlet stream 219. The outlet stream 219 may comprise mostly water and may be transported to a water treatment system (not shown) for further treatment. The second partial chamber 242 may comprise or may be coupled to a second outlet for carrying outlet stream 217. The hydrocarbon-water mixture 214 is withdrawn from the second partial chamber 242 and provided to the heat exchanger 220 as stream 217. The heat exchanger 220 may be a forced-flow thermosiphon, a natural-convection thermosiphon, calandria, kettle, or other applicable style exchanger to effectively increase the temperature of the fluid entering via the stream 217 and to initiate vaporization of light-end components intermingled with the heavy-end components comprising the bulk of the hydrocarbons in the stream 217. Additionally, an optional stream of gas 221 (from the separator 210 or elsewhere) may be utilized to assist with flow of the hydrocarbon-water mixture through this heat exchanger unit. The heating medium used to heat the hydrocarbon-water part of the incoming stream 217 may comprise any appropriate heating medium, such as air or water. The heating medium enters the heat exchanger 220 in stream 222 and exits the heat exchanger in stream 223. In typical scenarios, the heating medium does not intermingle with the hydrocarbon-water and/or vapor mixture in the heat exchanger 220.

Heated fluid exits the heat exchanger 220 in stream 224, and stream 224 is provided to the separator 210. After being heated in the heat exchanger 220, the stream 224 comprises gas 231 and liquid 232. The stream 224 enters the separator 210 via an inlet located relative to a third partial chamber 243 such that the liquid 232 is collected primarily in the third partial chamber 243. The partial chambers 241-243 are examples of regions, sections, or portions of the separator 210 in fluid communication with the vapor collection portion 251.

In this exemplary embodiment, the separator 210 further comprises a condenser 248. A cooling medium 240 may be provided to a condenser 248 for condensing some of the gas 231. In an embodiment, the condenser 248 may be shaped and located as a reflux (or drip-back or knock-back) condenser. Gas may collect in a portion of the separator 210 above the partial chambers 241-243. The separator 210 may comprise or may be coupled to a fourth outlet for carrying outlet stream 230. The outlet stream 230 may comprise mostly gas and may be transported to a gas conditioning system for further gas conditioning.

The condenser 248 may be located in the separator 210 directly above the third partial chamber 243 and is arranged to condense some vapor particles as they pass toward the outlet carrying outlet stream 230. Condensate 233 may, for example, form on the condenser 248 and then fall into the third partial chamber 243 due to gravity. Thus, the liquid 215 in the third partial chamber 243 may comprise liquid 232 and condensate 233. In this example, the liquid 215 comprises a higher concentration of hydrocarbons than the liquids 213 or 214.

The separator 210 further comprises a boot 216. The boot 216 is coupled to the third partial chamber 243, and the boot 216 permits further separation of the liquid 215 due to differences in density between various constituents. The liquid 215 in the boot 216 separates into a first constituent 244 and a second constituent 245. For example, the first constituent 244 is predominately water and collects at the bottom of the boot, and the second constituent 245 is predominately hydrocarbon and separates from the first constituent 244. Water 244 from the boot may proceed to further water treatment via stream 252 (which may be combined with stream 219 as shown), and hydrocarbons from the boot 216 may proceed to further hydrocarbon treatment via stream 218.

The performance of the separation system 200 in FIG. 2 has been compared against the performance of the separation system 100 in FIG. 1. Both systems were simulated using the same representative well stream having the same temperature, pressure, composition, and flow rate. In a simulated example, the separation system 200 used 11% less energy to process the simulated well stream than the conventional separation system 100, which helps to confirm that the separation system 200 yields OPEX savings. Furthermore, the separation system 200 is a less costly system than the separation system 100 due to a reduction in components, which leads to lower CAPEX. For example, the separation system 100 comprises two separators, a valve, and a compressor, whereas the separation system 200 comprises only one separator, which reduces capital outlays.

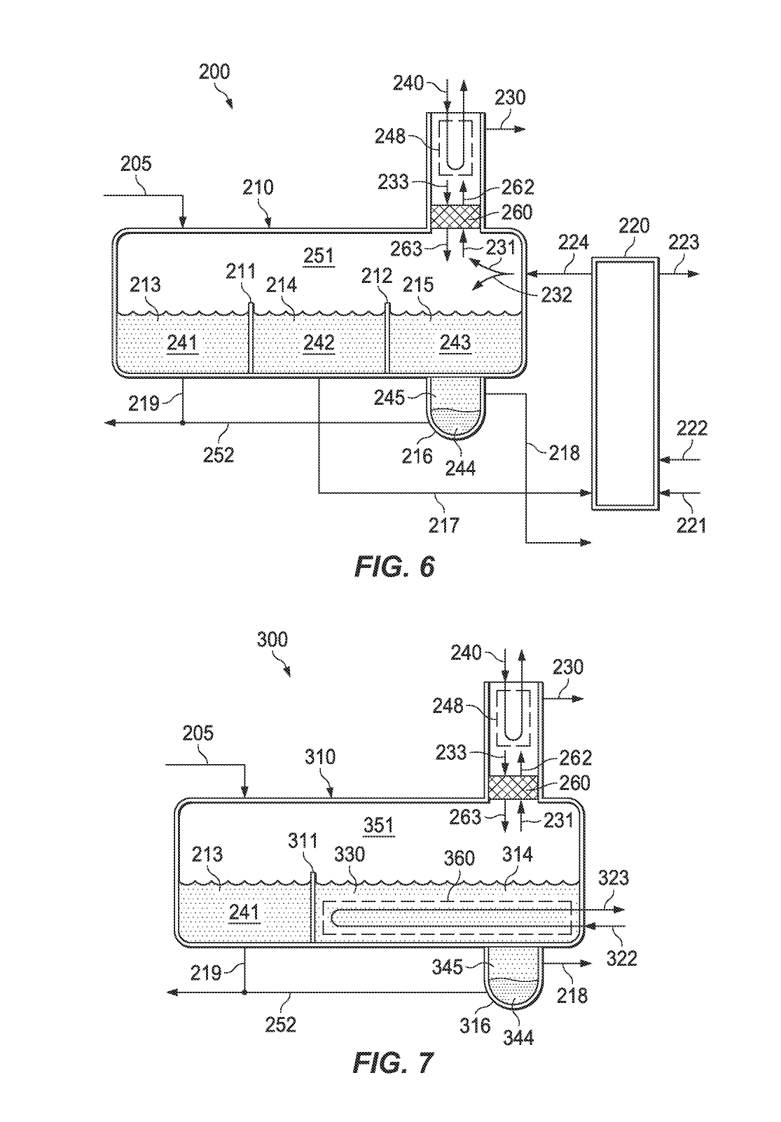

FIG. 6 is another schematic representation of an exemplary embodiment of a separation system 200 and the associated process flow, and is similar to the embodiment shown in FIG. 2. The separation system 200 comprises a separator 210 and a heat exchanger 220 similar to that depicted in FIG. 2. In addition to the configuration depicted in FIG. 2, the embodiment shown in FIG. 6 includes a mass transfer section 260 located between the condenser 248 and the separator 210. The component gas 231 of stream 224 enters the mass transfer section 260, exits as a hydrocarbon heavies depleted vapor 262, and proceeds to the condenser 248 for further processing as previously described in FIG. 2. Condensate 233 from the condenser 248 enters the mass transfer section 260, exits as a hydrocarbon heavies enriched liquid 263, and proceeds to the third partial chamber 243 for further processing as previously described for the process depicted in FIG. 2. The gas 231 and the condensate 233 preferentially flow counter-currently to each other within the mass transfer section 260. The mass transfer section 260 is comprised of internals of varying configurations (not shown) that are well known in the art for achieving mass transfer between liquid and gas streams. For example, these internals may be comprised of trays, shed decks, random packing, structured packing, grid packing, mesh, or other structures that promote the interaction of liquid and gas for the purpose of achieving effective mass transfer between said streams.

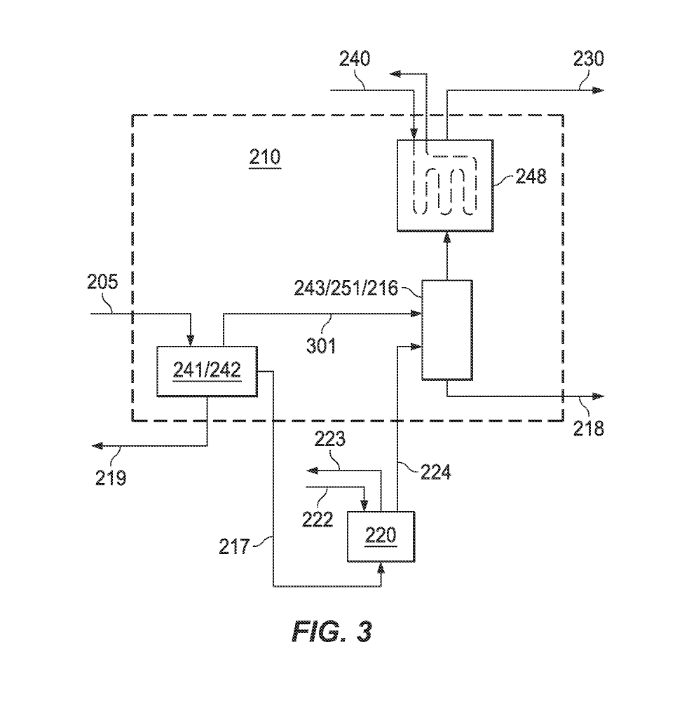

FIG. 3 is a simplified process flow diagram corresponding to the system 200 in FIG. 2. Stream 205 enters the separator 210 and is separated into partial chambers 241 and 242. The separator 210 operates at a single pressure, which may be the same pressure as the separator 110 in FIG. 1. For example, as one of ordinary skill in the art would recognize, since partial chambers 241 and 242 are within the separator 210 and the separator 210 comprises a single vessel, the pressure in the separator 210, and particularly in the partial chambers 241 and 242, is a single equilibrium pressure. The equilibrium pressure is generally a uniform value throughout the partial chambers 241 and 242, but a person of ordinary skill in the art would recognize that there may be small variations of pressure (e.g., less than 1% variation) throughout the volume due to random fluctuations. Accordingly, the pressure in partial chambers 241 and 242 is substantially the same.

Initially separated gas proceeds down the length of the separator 210 to reach another section 251 of the separator. Initially separated water 219 exits the heat-integrated separator for further water treatment. Initially separated hydrocarbon 217 exits the partial chamber 242 and proceeds though a heat exchanger 220 to heat the stream to a predetermined temperature, vaporizing part of the stream. From the heat exchanger, the stream 224 re-enters the separator 210 at another portion of the separator (labeled as 243/251/216). Upon re-entry into the separator 210, vapor and liquid separate. Liquid entering the separator 210 in stream 224 falls into a third partial chamber 243 and then proceeds to further hydrocarbon treatment in stream 218. Although not shown in FIG. 3, additional water separation may also take place in the boot 216 as depicted in FIG. 2. Vapor entering the separator 210 in stream 224 rises in the vessel, joining with initially separated vapor 301 and proceeds to the condenser 248. Within the condenser 248, condensable components fall back into the partial chamber 243, while gas exits the separator 210 for additional treatment via stream 230.

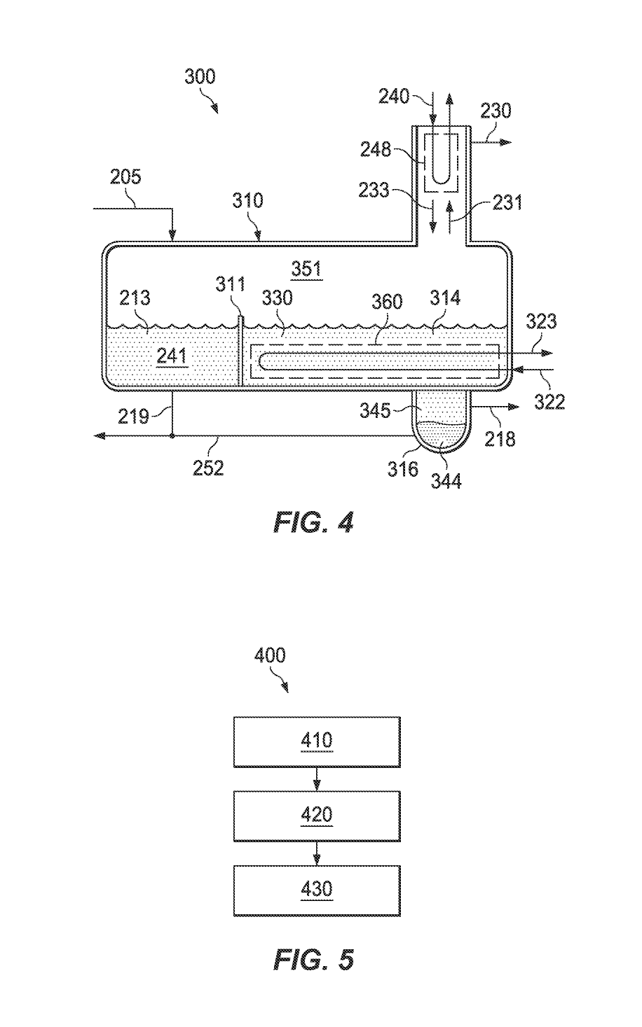

FIG. 4 is a schematic representation of another exemplary embodiment of a separation system 300 and the associated process flow. Elements of system 300 that are similar to corresponding elements of system 200 are given the same number. The system 300 comprises a separator 310, and the separator 310 receives a stream 205. As described previously, in some embodiments the stream 205 is received from a well or wellhead, and the stream 205 comprises a mixture of hydrocarbons, water, and gas. In some embodiments, there is no pressure drop from the wellhead and the stream 205 is at a temperature of about 30° C. to about 50° C.

A cross-section of the separator 310 is illustrated. In this example, the separator 310 comprises separation internals (not shown) that are well known in the art for separating water, hydrocarbon, and gas. As a result of the stream 205 interacting with separation internals, a first liquid 213 is collected in a first partial chamber 241 and a second liquid 314 is collected in a second partial chamber 330. The liquids 213 and 314 may be mixtures of water and hydrocarbons with different proportions or concentrations, with the first liquid 213 having a greater percentage of water than hydrocarbon and the second liquid 214 having a greater percentage of hydrocarbon than water. The partial chambers 241 and 330 can be defined by the outer walls of the separator 310 and divider 311. The divider 311 may be a plate or other rigid structure for dividing a portion of the separator 310 into partial chambers. A gas may collect in the vapor collection portion 351 of the separator 310 disposed above and in communication with the partial chambers 241 and 330.

As compared to the separator 210 in FIG. 2, the separator 310 employs the implementation of a heat exchanger 360 located in the second partial chamber 330 to initialize stabilization of hydrocarbon in the liquid 314. The heat exchanger 360 may comprise tubes or passages occupying part of the volume of partial chamber 330, and a heating medium may be contained in the tubes or passages. The heat exchanger 360 is configured to promote higher heat transfer at a lower portion (e.g., near the illustrated inlet portion of stream 322) of the separator 310 than at an upper portion (e.g., near the illustrated outlet portion of stream 323), thereby promoting an internal circulation to the liquid 314 to enhance disassociation and separation of light-end components intermingled with heavy-end components constituting the bulk of the hydrocarbons in the liquid 314. For example, the input inlet portion 322 may be in a relatively lower portion of the partial chamber 330 as compared to the upper outlet portion 323, so the heating medium in the heat exchanger 360 may provide more thermal energy in a lower portion of the partial chamber 330 than in an upper portion of the partial chamber 330. Thus, the heat exchanger 360 may induce a temperature gradient in the liquid 314 in which the liquid is warmer in a lower portion of the partial chamber 330 than in an upper portion of the partial chamber 330. The fluid used to heat the hydrocarbon-water part of the incoming well stream fluid in the heat exchanger 360 may comprise any appropriate heating medium, such as air or water.

A vapor component 231 released from the liquid 314 due at least in part to heating mixes with free gas already passing through the separator 310 and proceeds to a second heat exchanger of this process—condenser 248. As discussed previously, the condenser 248 may be a reflux (or drip-back or knock-back) condenser. Within the condenser 248, the exiting gas temperature can be controlled to remove undesired condensable components via a cooling medium passing through tubes (or passages) encased within the condenser 248. A fluid used to condense part of the gas within the condenser 248 may comprise any appropriate coolant, such as air or water. The condenser 248 may be located in the separator 310 directly above the second partial chamber 330 so that condensate 233 from the condenser 248 refluxes or drips-back directly within the separator 310. The resulting treated or pre-conditioned gas 230 then proceeds to further gas conditioning. The separator 310 comprises a boot 316 that facilitates further separation of the liquid 314 into water 344 and hydrocarbon 345.

FIG. 7 is another schematic representation of an exemplary embodiment of a separation system 300 and the associated process flow, and is similar to the embodiment shown in FIG. 4. The separation system 300 comprises a separator 310. In addition to the configuration depicted in FIG. 4, the embodiment shown in FIG. 7 includes a mass transfer section 260 located between the condenser 248 and the separator 310. The vapor component 231 released from the liquid 314 enters the mass transfer section 260, exits as a hydrocarbon heavies depleted vapor 262, and proceeds to the condenser 248 for further processing as previous described in FIG. 4. Condensate 233 from the condenser 248 enters the mass transfer section 260, exits as a hydrocarbon heavies enriched liquid 263, and proceeds to the second partial chamber 230 for further processing as previously described for the process depicted in FIG. 4. The vapor component 231 released from the liquid 314 and the condensate 233 preferentially flow counter-currently to each other within the mass transfer section 260. The mass transfer section 260 is comprised of internals of varying configurations (not shown) that are well known in the art for achieving mass transfer between liquid and gas streams. For example, these internals may be comprised of trays, shed decks, random packing, structured packing, grid packing, mesh, or other structures that promote the interaction of liquid and gas for the purpose of achieving effective mass transfer between said streams.

The separators 210 and 310 in FIGS. 2 and 4, respectively, may be referred to as horizontal separators because a horizontal dimension is greater than a vertical dimension. Additionally, the partial chambers 241/242/243 and/or 241/351 may be disposed such that each partial chamber is horizontally adjacent to another partial chamber. The principles and embodiments described herein are also applicable to vertical separators, or separators whose vertical dimension is greater than a horizontal dimension.

A further embodiment of a separation system (not shown) and the associated separation process may comprise heating either internally (e.g., using a heat exchanger similar to 360) or externally (e.g., using a heat exchanger similar to 220) by similar aforementioned methods the liquid 213 in the first partial chamber 241 of either separator 210 or separator 310 to accelerate the separation of hydrocarbons and water in a collection boot or in subsequent equipment located downstream of the separator. A heat exchanger configured similarly to heat exchanger 220 or heat exchanger 360 may be used for this purpose.

FIG. 5 is a flowchart setting forth an exemplary method 400 for processing fluid from a wellhead using a single separator. The method 400 may be implemented in a separator, such as separator 210 or 310. The method 400 begins in block 410. In block 410, fluid is received from a wellhead into a separator. The fluid may be received via an inlet of the separator, and the fluid may be produced intermittently or continuously by a hydrocarbon source. In some embodiments, instead of being received from a wellhead, the fluid is received from other sources, such as a storage facility or other locations. The method may proceed to block 420 in which a first stage of separation is performed in the separator. The first stage of separation may comprise separating liquid from gas and collecting the liquid in one or more partial chambers of the separator. For example, if a separator 210 or 310 is employed, liquid may be collected in partial chambers 241 and 242 as described previously. An example first stage separation section of separators 210 or 310 can comprise various combinations of an inlet for receiving a stream, separation internals, and partial chambers. A first stage separation section may perform blocks 410 and 420.

The method may next proceed to block 430. In block 430, a second stage of separation is performed in the same separator. The second stage of separation comprises performing additional separation of liquid from gas and may comprise further separation of the liquid into constituent components, such as hydrocarbons and water. The second stage of separation may comprise using a heat exchanger, such as heat exchanger 220 with separator 210 or heat exchanger 360 with separator 310 as described previously. Vapor may be produced from the use of a heat exchanger and may be treated using a condenser, such as condenser 248. Gas produced in this process is withdrawn from the separator for further gas treatment. Mass transfer between vapor and liquid may occur in an optional mass transfer section 260 located between the condenser 248 and the separator 210 or 310.

An example second stage separation section of separator 210 for performing block 430 can comprise various combinations of an inlet for receiving a heated flow from a heat exchanger, a partial chamber for receiving liquid from the heated flow, and a boot integral with the partial chamber. An example second stage separation section of separator 310 for performing block 430 can comprise various combinations of a partial chamber, a heat exchanger within the partial chamber, and a boot integral with the partial chamber.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

1. A system for separating a fluid mixture into different components, the system including:
a separator including:
a first inlet configured to receive a stream of the fluid mixture;
a first stage separation section configured to provide a first stage of separation at a first temperature to separate the stream into a first liquid, a second liquid, and a first gas;
a second stage separation section disposed horizontally adjacent to the first stage separation section and in fluid communication with the first stage separation section, wherein the second stage separation section is configured to provide a second stage of separation at a second temperature higher than the first temperature to further separate a second gas from the second liquid; and
a gas collection section in fluid communication with the first stage separation section and the second stage separation section, and configured to receive the first gas and the second gas to form a gas mixture.

2. The system of claim 1, wherein the first stage separation section comprises a first partial chamber and a second partial chamber, wherein the first partial chamber is configured to collect the first liquid, and wherein the second partial chamber is configured to collect the second liquid.

3. The system of claim 2, wherein the first stage of separation and the second stage of separation occur within the same vessel.

4. The system of claim 2, further including:
a heat exchanger coupled to the separator, wherein the heat exchanger is configured to:
receive a stream of the second liquid from the separator;
provide heat to the stream of the second liquid to generate a heated stream; and
produce the heated stream to the separator,
and wherein the separator further comprises a third partial chamber configured to collect a liquid portion of the heated stream.

5. The system of claim 4, wherein the gas collection section comprises a gas outlet, wherein the gas outlet comprises a condenser configured to cool the gas mixture and generate a condensate, and wherein the condenser is positioned so that the condensate collects in the third partial chamber.

6. The system of claim 4, wherein the separator further comprises a boot coupled to a bottom end of the third partial chamber.

7. The system of claim 4, wherein the separator further comprises a mass transfer section located between the condenser and the separator in which condensate from the condenser passes downward through a mass transfer section counter-current to rising vapor from the separator.

8. The system of claim 2, wherein the separator further comprises a second inlet configured to receive a stream of the second liquid that has been heated by a heat exchanger, wherein the second inlet is located near the third partial chamber to allow a component of the second liquid to fall into the third partial chamber.

9. A vessel for separating a mixture into different components, the vessel including:
an inlet configured to receive the mixture;
a first partial chamber configured to receive a first component of the mixture;
a second partial chamber disposed horizontally adjacent to the first partial chamber and configured to receive a second component of the mixture;
a heat exchanger located in the second partial chamber configured to transfer thermal energy to the second component to vaporize a portion of the mixture and separate a vapor from the second component;
a vapor collection portion disposed above and in communication with the first partial chamber and the second partial chamber and configured to receive the vapor; and
a vapor outlet configured to pass the vapor from the vessel.

10. The vessel of claim 9, wherein the first partial chamber is arranged to maintain the first component at a first temperature, and wherein the second partial chamber is arranged to maintain the second component is at a second temperature.

11. The vessel of claim 9, wherein the heat exchanger is configured to provide greater heat to a lower portion of the second partial chamber than in an upper portion of the second partial chamber to provide for circulation of the second component.

12. The vessel of claim 9, wherein the heat exchanger comprises tubing configured to receive a heating medium to transfer thermal energy to the second component.

13. The vessel of claim 9, further including a boot connected to the second partial chamber configured to permit further separation of the second component into a water component and a hydrocarbon component.

14. The vessel of claim 9, further including a mass transfer section located between the condenser and the separator in which condensate from the condenser passes downward through a mass transfer section counter-current to rising vapor from the separator.

15. A method of separating a stream in a separator, the method including:
separating the stream into a first component and a second component;
separating the second component from a third component at a higher temperature than the first component, wherein the first component comprises a first mixture of water and hydrocarbon, wherein the second component comprises a second mixture of water and hydrocarbon, wherein the second mixture has a higher concentration of hydrocarbon than the first mixture, and wherein the third component comprises a gas; and
passing at least a portion of the second component out of the separator; and
passing at least a portion the third component out of the separator.

16. The method of claim 15, wherein the stream is received from a wellhead, wherein separating the stream and separating the second component are performed at substantially the same pressure, wherein the first component occupies at least part of a first section of the separator, wherein the second component occupies at least part of a second section of the separator, and wherein the third component occupies at least part of a third section of the separator.

17. The method of claim 15, further including:
performing a third stage of separation of the stream into a fourth component, wherein the fourth component comprises a third mixture of water and hydrocarbon, and wherein the third mixture has a higher concentration of hydrocarbon than the second mixture.

18. The method of claim 15, wherein performing the second stage of separation comprises heating the second component in the separator using a heat exchanger located in the second section of the separator.

19. The method of claim 16, further comprising:
withdrawing the second component from the separator;
heating the second component; and
returning the heated second component to the separator for further separation.

20. The method of claim 19, wherein the heated second component comprises a heated liquid portion and a vapor portion, and wherein the heated liquid portion falls into the third section.

21. The method of claim 20, further comprising cooling the vapor portion such that a condensate separates from the vapor portion and falls into the third section, and wherein a gas remaining after removing the condensate is withdrawn from the separator for further processing.

22. The method of claim 21, wherein cooling the vapor portion further comprises cooling a second vapor portion obtained from the first component.

23. The method of claim 21, wherein the separated condensate passes downward through a mass transfer section counter-current to rising vapor from the separator.
